(19) United States
(12) Patent Application Publication
(10) Pub. No.: US 2002/0043804 A1
(43) Pub. Date: Apr. 18, 2002

(54) Fixation and anti-leakage socket joint

(76) Inventors: Chung Shan Shen, Tai Chung City (TW); Jyuhn Liarng Shen, Tai Chung City (TW)

Correspondence Address: Chung Shan Shen, P.O. BOX 63-150, Taichung City, TW

(21) Appl. No.: 09/961,583

(22) Filed: Sep. 22, 2001

(30) Foreign Application Priority Data
Jan. 6, 2000 (TW) 89100169

(51) Int. Cl. F16L 21/06

(52) U.S. Cl. 285/322

(57) ABSTRACT

The present invention discloses an improved structure of a fixation and anti-leakage socket joint, comprising a soft tube, a blocking ring in the inner tube, a fixation ring on the outer tube and two fitting rings around the both ends of the tube; a blocking ring in the inner socket; a soft tube completely wraps the adjustable pipes; the thread on the socket; the elastic grips extended from the socket; two caps on both sides of the socket. When the caps are fastened, the elastic grips are squeezed inwards to compress the soft tube and therefore fix the pipes. Such socket joint provides a fixation and anti-leakage device for the users to handle the adjustable pipes more easily and safely.

### BACKGROUND OF THE INVENTION

1. Field of the Invention

The present invention relates to a socket joint, more particularly to the structure of a fixation and anti-leakage device for cleaning kits to prevent leakage and to fixedly fasten pipes of different sizes. When the cleaning kit is connected with an adjustable handle by the socket joint, users can reach the top of the house or building more easily and can operate the cleaning kit more safely.

2. Description of the Related Art

In general, the conventional anti-leakage structure of an adjustable water pipe (Patent No. 347042, issued by Republic of China on Dec. 1, 1998. Application No. 87306107, dated on Apr. 22, 1998) as shown in attached document, mainly comprises a socket joint 11 at the front end of the handle 53. The washer 10 of the socket joint is squeezed inwards with a screw nut 12 to fasten the adjustable pipes. On the other side of the adjustable pipe 50 has a plug 14 with a convex ring in the middle. The rear part of the pipe has one or more grooves to fit over the blocking ring 15, and therefore to prevent leakage. However, the handle 53 and the adjustable pipe 50 are connected and fastened by a socket joint 11 only. It is not firm enough.

Therefore, in summation of the above description of the structural design of the socket joint, particularly a fixation and anti-leakage structure is the research and development subject for enhancement. The inventor of the present invention based on years of experience in the related industry conducted extensive research to enhance the structure of a fixation and anti-leakage socket joint herein which is hereby submitted for patent application.

### SUMMARY OF THE INVENTION

The primary objective of the present invention is to provide an improved structure of a fixation and anti-leakage socket joint, so that the cleaning kit for example water gun and sweeping brush, which are mounted on the adjustable pipe, can reach the top of the house or building more easily and safely. It further gives a relatively ideal efficient measure.

The present invention discloses an improved structure of a socket joint, comprising an anti-leakage soft tube to completely wrap up the pipes of different sizes; the blocking rings both in the inner tube and on the outer tube to block the large and small pipes respectively; the cap to compress the elastic grips; the elastic grips of the socket joint are squeezed inwards to fix the pipes firmly, and therefore have the functions of fixation, adjustable and anti-leakage at the same time.

To make it easier for our examiner to understand the objective of the invention, its structure, innovative features, and its performance, we use two preferred embodiments together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the three-dimensional diagram of the disassembled parts of the present invention.

FIG. 2 shows the three-dimensional diagram of the present invention.

FIG. 3 shows the sectional diagram of the present invention before fastening the caps.

FIG. 4 shows the sectional diagram of the present invention after fastening the caps.

FIG. 5 is a diagram showing the operation of a socket joint according to a preferred embodiment of the present invention.

FIG. 6 shows the sectional diagram of the present invention after adjusting the small pipe to an intended length.

FIG. 7 is a diagram showing the operation of another preferred embodiment of the present invention.

### DETAILED DESCRIPTION OF THE PREFERRED EMBODIMENTS

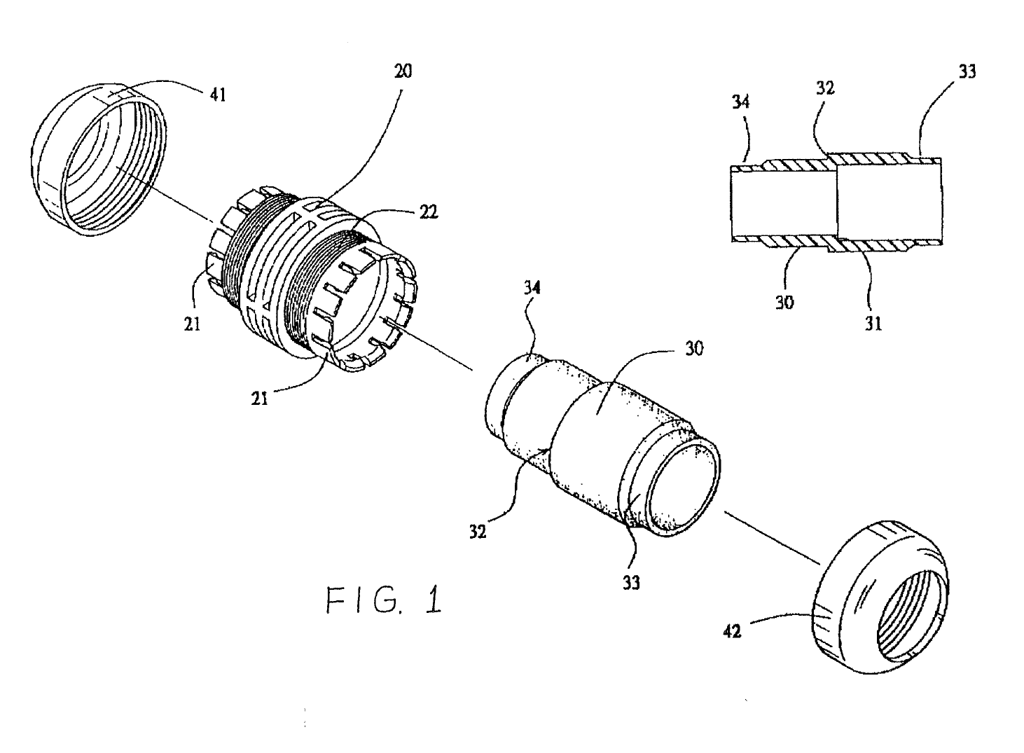

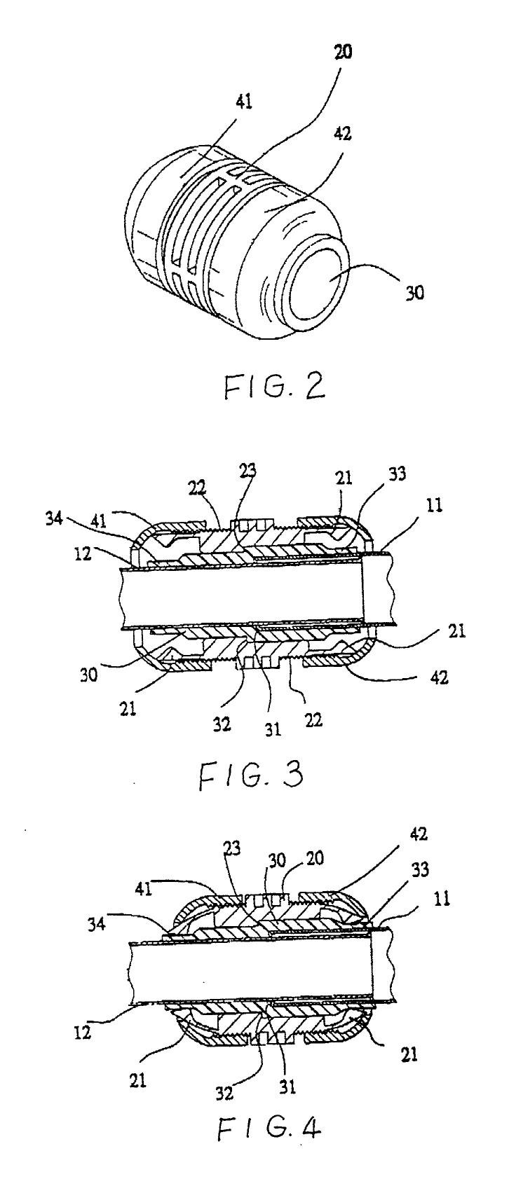

Please refer to FIG. 1. A fixation and anti-leakage socket joint 20 is shown having a soft anti-leakage tube inside the socket. The soft tube also serves as a cover to wrap up the large pipe 11 and small pipe 12 of an adjustable pipe. In the middle section of the inner tube, a blocking ring 31 is mounted to prevent the slide of the large pipe 11. In the middle section of the outer tube, a fixation ring 32 is mounted to fix the tube and the socket. Fitting rings 33; 34 are respectively mounted around the front part and rear part of the soft tube 30. Inside the socket joint 20, a blocking ring 23 in mounted to fit over the fixation ring 32. Then the tube and the socket are fixed together. Around the front part and rear part of the socket joint 20 are thread 22, where the elastic grips are extended.

Please refer to FIG. 3. The front part of the large pipe 11 is extended to fit over the blocking ring 31 inside the tube 30. The small pipe 12 is extended to the first half of the tube. The soft tube wraps up both the large and small pipes completely.

Please refer to FIG. 4. When the caps 41; 42 of the socket joint 20 is fastened, the elastic grips are squeezed inwards to compress both ends of the tube 30, fix the large and small pipes, and therefore have the functions of fixation and anti-leakage at the same time.

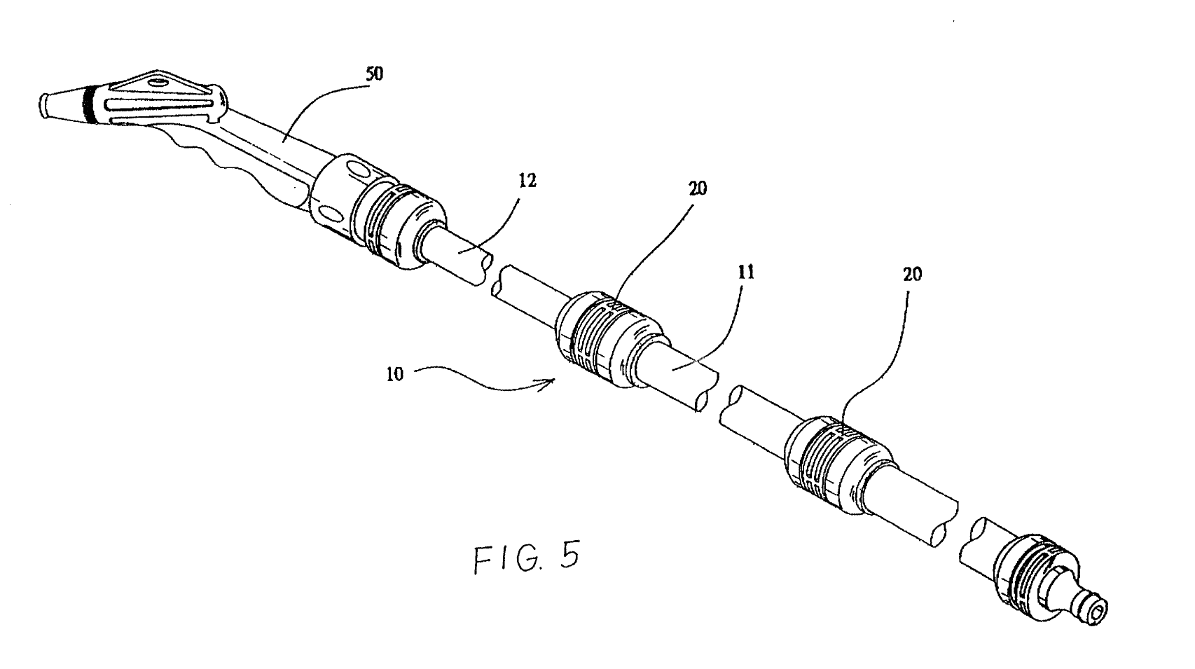

Please refer to FIG. 5. When a cleaning kit for example water gun and sweeping brush is connected with an adjustable pipe 10 by the socket joint, the users can reach the top of the house or building more easily and can operate the cleaning kit more safely.

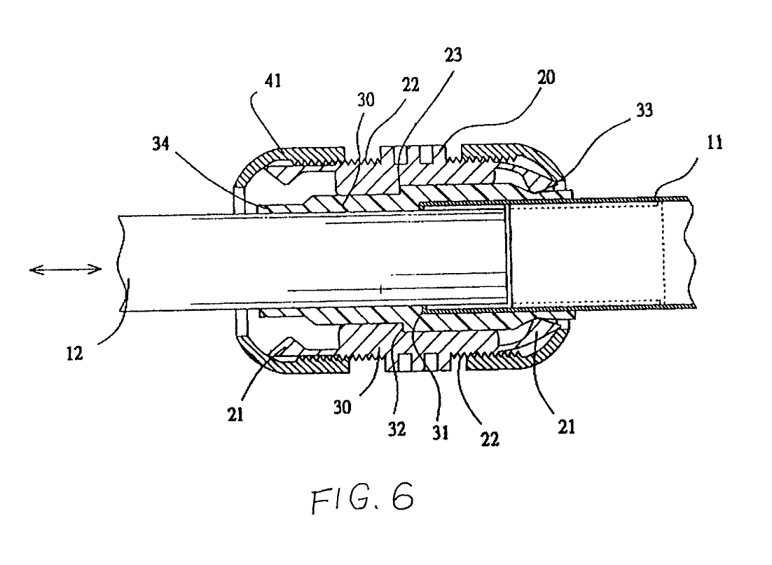

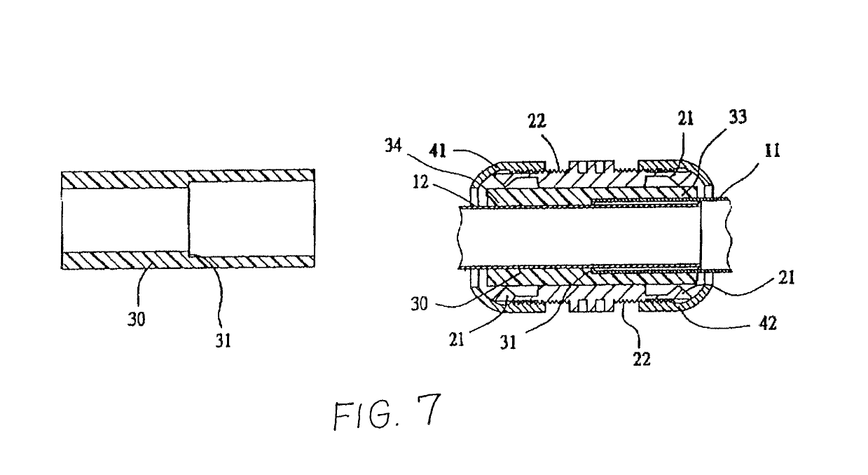

Please refer to FIG. 6. To adjust the length of the pipe 10, just loose the cap 41 at the front part of the socket joint 20, push the elastic grips back to its former position, and slide the small pipe to the intended length. Fasten the cap 41 again to fix the small pipe.

In addition to the foregoing embodiment, the present invention can be implemented as in the second preferred embodiment as described below. Please refer to FIG. 7. Only a blocking ring 31 is formed as an integral part in the inner tube to have the function of the foregoing embodiment.

Therefore, in summation of the above description, the present invention herein prevents leaking and can fixedly fasten pipes that the structure of the conventional socket joint may not offer. It further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A structure of a fixation and anti-leakage socket joint, comprising a soft tube, a blocking ring in the inner tube, a fixation ring on the outer tube and two fitting rings around the both ends of the tube; a blocking ring in the inner socket; a soft tube completely wraps the adjustable pipes; the thread on the socket; the elastic grips extended from the socket; two caps on both sides of the socket. When the caps are fastened, the elastic grips are squeezed inwards to compress the soft tube and therefore fix the pipes. Such socket joint provides a fixation and anti-leakage device for the users to handle the adjustable pipes more easily and safely.

2. A structure of a fixation and anti-leakage socket joint according to claim 1, wherein the blocking ring can be mounted in the inner tube only to block the large pipe and have the same on as described above.
